(19) United States
(12) Patent Application Publication
(10) Pub. No.: US 2025/0364927 A1
(43) Pub. Date: Nov. 27, 2025

(54) METHODS, SYSTEMS, APPARATUSES FOR COMPRESSOR TORQUE RIPPLE COMPENSATION

(71) Applicant: STMicroelectronics International N.V., Geneva (CH)

(72) Inventors: Weilong ZHENG, Shenzhen (CN); Chengpan CAI, Shenzhen (CN); Dino COSTANZO, Catania (IT)

(21) Appl. No.: 18/673,503

(22) Filed: May 24, 2024

(51) Int. Cl. H02P 6/10; H02P 6/28; H02P 21/00

(52) U.S. Cl. CPC H02P 6/10; H02P 6/28; H02P 21/0003

(57) ABSTRACT

Methods, systems, and apparatuses for improved torque ripple compensation for motors experiencing torque ripple are provided. For example, a method of torque ripple compensation includes receiving a speed difference signal associated with a difference between a motor speed and a reference speed. Then generating a torque compensation signal by: generating, via an α-β construct, one or more α-β signals based on the speed difference signal; converting, via a Park transform, the α-β signals to one or more transformed signals; filtering the transformed signals with one or more low pass filters to provide one or more filtered signals; regulating, via one or more PI regulators, the filtered signals to provide one or more regulated signals; converting, with an inverse Park transform, the regulated signals to a torque compensation signal. Then control a motor based at least on the torque compensation signal.

### TECHNOLOGICAL FIELD

Example embodiments of the present disclosure relate generally to controlling motors, particularly for controlling compressor motors to compensate for torque ripple.

### BACKGROUND

In various applications with motors, such as air conditioners and refrigerators a motor will be used. The motor, such as for a compressor, will be started. The compressor, when started, may vibrate. For example, in home air conditioners and refrigerators, a single rotary compressor may be used. In each mechanical cycle, the compressor load torque may fluctuate due to the compressor charge and discharge pressure process. The fluctuations in load torque may cause the compressor's speed to fluctuate with the frequency of the mechanical speed. The speed fluctuations may cause mechanical vibrations that reduce the service life of the device.

Conventional systems may add a sinusoidal compensation signal to the compressor torque reference. However, such conventional systems require a lot of time to tune the compensation amplitude and angle of this sinusoidal signal. This is because for each compressor, even the same compressor under different loads, the compensation amplitude and angle are different. Thus the compensation amplitude and angle need to be tuned carefully for each compressor and the compensation amplitude and angle will change a little bit under different compressor load.

The inventors have identified numerous areas of improvement in the existing technologies and processes, which are the subjects of embodiments described herein. Through applied effort, ingenuity, and innovation, many of these deficiencies, challenges, and problems have been solved by developing solutions that are included in embodiments of the present disclosure, some examples of which are described in detail herein.

### BRIEF SUMMARY

Various embodiments described herein relate to methods, systems, and apparatuses for improved torque ripple compensation for motors experiencing torque ripple are provided.

In accordance with some embodiments of the present disclosure, an example method of torque ripple compensation is provided. The method of torque ripple compensation comprises: receiving a speed difference signal, wherein the speed difference signal is associated with a difference between a motor speed and a reference speed; generating a torque compensation signal by: generating, via an α-β construct, one or more α-β signals based speed difference signal; converting, via a Park transform, the one or more α-β signals to one or more transformed signals; filtering the one or more transformed signals with one or more low pass filters to provide one or more filtered signals; regulating, via one or more PI regulators, the one or more filtered signals to provide one or more regulated signals; converting, with an inverse Park transform, the one or more regulated signals to a torque compensation signal; and controlling a motor based at least on the torque compensation signal.

In accordance with some embodiments of the present disclosure, an example apparatus for torque ripple compensation is provided. The apparatus for torque ripple compensation comprising: a memory; a processor; a motor controller configured to control a motor and communicable with the processor and the memory, wherein the motor controller is further configured to: receive a speed difference signal, wherein the speed difference signal is associated with a difference between a motor speed and a reference speed; generate a torque compensation signal by: generate, via an α-β construct, one or more α-β signals based speed difference signal; convert, via a Park transform, the one or more α-β signals to one or more transformed signals; filter the one or more transformed signals with one or more low pass filters to provide one or more filtered signals; regulate, via one or more PI regulators, the one or more filtered signals to provide one or more regulated signals; convert, with an inverse Park transform, the one or more regulated signals to a torque compensation signal; and control a motor based at least on the torque compensation signal.

In accordance with some embodiments of the present disclosure, an example system for torque ripple compensation is provided. The system for torque ripple compensation comprising: a motor; a memory; a processor; a motor controller configured to control the motor and communicable with the processor and the memory, wherein the motor controller is further configured to: receive a speed difference signal, wherein the speed difference signal is associated with a difference between a motor speed and a reference speed; generate a torque compensation signal by: generate, via an α-β construct, one or more α-β signals based speed difference signal; convert, via a Park transform, the one or more α-β signals to one or more transformed signals; filter the one or more transformed signals with one or more low pass filters to provide one or more filtered signals; regulate, via one or more PI regulators, the one or more filtered signals to provide one or more regulated signals; convert, with an inverse Park transform, the one or more regulated signals to a torque compensation signal; and control a motor based at least on the torque compensation signal.

In some embodiments, generating the torque compensation compensates for the first order frequencies and the second order frequencies.

In some embodiments, the speed difference signal is received based on a speed signal determined by one or more 3D accelerometers an encoder, or a sensorless algorithm.

In some embodiments, generating the torque compensation signal occurs when the motor speed is above a first threshold.

In some embodiments, generating the torque compensation signal occurs when a speed signal is in a range above a first threshold and below a second threshold.

In some embodiments, the method is performed by a motor controller.

In some embodiments, the first threshold is 20 Hz and the second threshold is 40 Hz.

In some embodiments, the motor is a compressor motor for an air conditioner or a refrigerator.

The above summary is provided merely for purposes of summarizing some example embodiments to provide a basic understanding of some aspects of the disclosure. Accordingly, it will be appreciated that the above-described embodiments are merely examples and should not be construed to narrow the scope or spirit of the disclosure in any way. It will also be appreciated that the scope of the disclosure encompasses many potential embodiments in addition to those here summarized, some of which will be further described below.

### BRIEF SUMMARY OF THE DRAWINGS

Having thus described certain example embodiments of the present disclosure in general terms, reference will now be made to the accompanying drawings, which are not necessarily drawn to scale, and wherein:

FIG. 1 illustrates exemplary diagrams of a compressor and associated torques in accordance with one or more embodiments of the present disclosure;

FIGS. 2A & 2B illustrate exemplary graphs of toque lead speeds and alpha-beta constructors in accordance with one or more embodiments of the present disclosure;

FIG. 3 illustrates an exemplary block diagram of a flowchart of operations for motor control in accordance with one or more embodiments of the present disclosure;

FIG. 4 illustrates a first exemplary block diagram of a flowchart of operations for generating a torque compensation signal in accordance with one or more embodiments of the present disclosure;

FIG. 5 illustrates a second exemplary block diagram of a flowchart of operations for generating a torque compensation signal in accordance with one or more embodiments of the present disclosure;

FIGS. 6A-6D illustrates an exemplary block diagram of a flowchart of operations for an alpha-beta constructor and related graphs in accordance with one or more embodiments of the present disclosure;

FIG. 7 illustrates exemplary operations for generating a torque compensation signal in accordance with one or more embodiments of the present disclosure; and

FIG. 8 illustrates an exemplary device in accordance with one or more embodiments of the present disclosure.

### DETAILED DESCRIPTION

Some embodiments of the present disclosure will now be described more fully herein with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in various embodiments,” “in one embodiment,” “according to one embodiment,” “in some embodiments,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments or it may be excluded.

The use of the term “circuitry” as used herein with respect to components of a system or an apparatus should be understood to include particular hardware configured to perform the functions associated with the particular circuitry as described herein. The term “circuitry” should be understood broadly to include hardware and, in some embodiments, software for configuring the hardware. For example, in some embodiments, “circuitry” may include processing circuitry, communications circuitry, input/output circuitry, and the like. In some embodiments, other elements may provide or supplement the functionality of particular circuitry.

### Overview

Various embodiments of the present disclosure are directed to improved torque ripple compensation for motors experiencing torque ripple.

In various applications with motors, such as air conditioners and refrigerators, mechanical vibration(s) is commonly experienced by a compressor motor associated with a compressor due to compressor load torque ripple. The load torque ripple is associated with fluctuations in load torque that that the motor experiences when operating a compressor. The fluctuations or vibrations may, among other things, degrade operations, usable life, efficiency, sustainability, etc.

Compressor vibrations may be caused by the load on the compressor. The load may cause torque ripple, which is periodic disturbances in torque and causes noise vibrations. Torque ripple compensation suppresses such vibrations caused by torque ripple.

For example, in home air conditioners and refrigerators there may be a single rotary compressor that, with each mechanical cycle, may have the compressor's load torque fluctuate due to the compressor charge and discharge pressure processes). The fluctuations may cause torque ripple. Due to the torque ripple, the compressor's speed fluctuates with the frequency of mechanical speed, such as measured by a 3-axis accelerometer. The speed fluctuation may cause mechanical vibration(s).

This present disclosure describes a method for torque ripple compensation to suppress mechanical vibrations. Additionally, and in contrast to conventional methods, the present disclosure does not require any additional sensors. Various embodiments of the present disclosure further provide for automatic compensation for torque fluctuations. Additionally, various embodiments may provide for simple debugging and deployment. Various embodiments include a torque ripple compensator to suppress speed fluctuation(s) and remove mechanical vibration(s).

The torque compensator generates an electromatic torque equalizing the load torque (e.g., of a compressor) so that the speed keeps constant and an experienced mechanical vibration is reduced. The present disclosure may be applied to suppress the mechanical vibration caused by compressors in various applications, including but not limited to air conditioners and refrigerators. Additionally, various embodiments may address harmonics. For example, various embodiments may reduce speed fluctuations related to a frequency, 1st order, 2nd order, and the like to an nth order harmonic of the frequency.

In various embodiments, the only input signal is the torque compensator may use is a delta speed signal. A Park transform may be used to convert the fluctuating delta speed signal into a DC signal based on a direct-quadrature (d-q) axes. The DC signal is used to determine a compensation torque for each axis of the d-q axes (e.g., a Td and a Tq) by utilizing a PI regulator. The compensation signal is generated using an inverse Park transform applied to the output of the PI regulator. The compensation signal may be used by the motor controller to control the speed of a motor to compensate for torque ripple.

In various embodiments, the motor controller may include more than one mode, such as 1st order frequency mode where the motor controller additional compensations for 1st order frequency torque ripple compensation. Enabling this 1st order mode, the accelerations of the XYZ axis are reduced greatly and the mechanical vibration is further suppressed as well. The enabling of these higher order modes may be turned on and/or off at frequency thresholds. For example, a frequency threshold may be enabling such models when the frequencies are in a first range, such as between 20 Hz and 40 Hz. In various embodiments, the vibrations and/or fluctuations may be measured indirectly by a 3-axis accelerometer, which may provide a signal to enable a torque compensator.

### Exemplary Methods, Systems, and Apparatuses

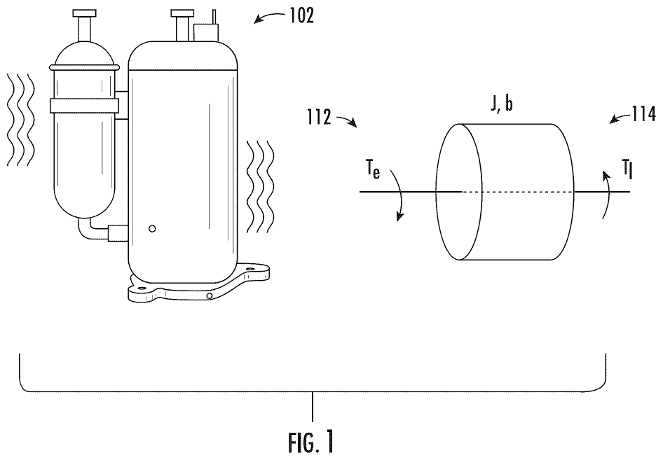

FIG. 1 illustrates exemplary diagrams of a compressor and associated torques in accordance with one or more embodiments of the present disclosure. A compressor 102 may experience vibrations and/or torque fluctuations at a motor, particularly a motor shaft. A motor via a motor shaft may provide a torque to operate the compressor 102. A motor torque provided in a first rotational direction by the motor may be opposed by a load torque in a second rotational direction that is opposite the first rotation direction. The difference between the motor torque and the load torque is equal to the following formula:

$$T e - T l = J \frac{d ω}{d t} + b ω$$

Te is motor torque;
Tl is load torque;
J is the compressor inertia;
b is compressor coefficient of friction, which is very small and may be disregarded;
ω is the speed of the motor; and
dω/dt is the first time derivative of speed.

The motor torque minus the load torque may be substituted with T. In steady state operations without fluctuations or vibrations T should be zero as there are no speed fluctuations. In various embodiments, a sensor may detect speed or the speed may be determined by the controller.

The speed bandwidth is not far greater than mechanical speed frequency and there exist delay in torque loop regulation and observed speed. Te can not compensate the Tl fluctuation in time. Additionally, total torque T is 90 deg ahead of the actual speed AC component ω_{ac}, which may be as set out in following formula:

$$Δ ω = {ω}_{r e f} - ω = - {ω}_{a c}$$

In various embodiments, Δω reflects the mechanical vibration and its frequency is the same frequency as mechanical speed frequency.

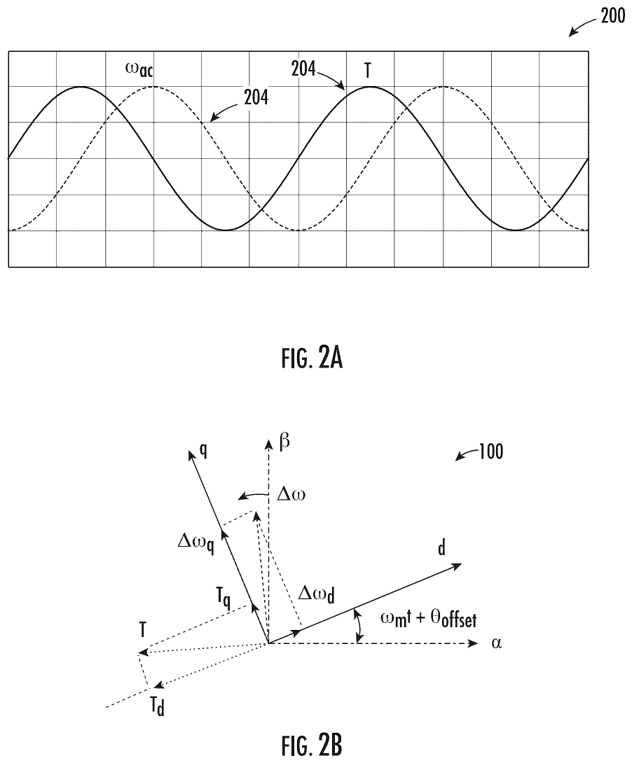

FIGS. 2A & 2B illustrate exemplary graphs of toque lead speeds and alpha-beta constructors in accordance with one or more embodiments of the present disclosure. FIG. 2A illustrates a first graph of total torque T and speed AC component ω_{ac}. As illustrated, the torque T leads the speed AC component ω_{ac} by 90 degrees.

FIG. 2B illustrates the relationship between the speed difference and the compensation torque and well as the components in the direct-quadrature axes. As illustrated, in the alpha-beta axes, the beta axis lags the alpha axis by 90 degrees. A Park transformation transforms values using an alpha-beta axes to the direct-quadrature (d-q) axes. Similarly, an inverse Park transformation transforms values using the d-q axes to those using the alpha-beta axes. To control for speed fluctuations, a Park transformation may be used to extract the amplitude of Δω, which may then be used to obtain the torque compensation amplitude T as described herein.

From a delta speed signal, may perform an alpha-beta (α-β) constructor operation to generate two signals in the alpha-beta axes: (i) a delta omega signal on the alpha axis (Δω_α) and a delta omega signal on the beta axis (Δω_β).

For Δω in the d-q coordinates of Δωd and Δωq, to compensate for the Δωd may generate a Tq that is 90 degrees ahead of the Δωd. Similarly, to compensate for a Δωq may generate a Td that is 90 degrees ahead of the Δωq.

For torque compensation, may use a Δω signal, such as Δω_α, as an input and may also have an output of a torque compensation signal. The torque compensation signal may be added to a motor control torque being used to control the angle of the motor shaft driving the compressor.

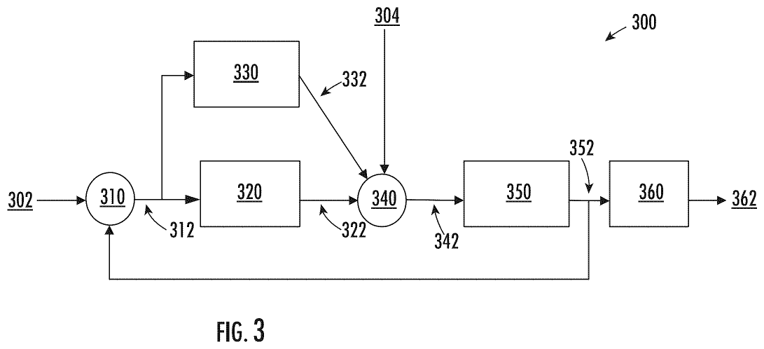

FIG. 3 illustrates an exemplary block diagram of a flowchart of operations for motor control in accordance with one or more embodiments of the present disclosure. The operations may be used to control a motor of a compressor 350, including to control a speed and an angle of rotation (θ) of the motor shaft in the compressor 350. In various embodiments, each of the signals illustrated and described herein may be a current signal associated with the variable described where the amplitude of the respective current is associated with the respective variable.

A reference speed signal 302 (ωref) is received by a comparator that compares the reference speed signal 302 (ωref) to the current ω signal. By subtracting the current ω signal from the reference speed signal 302 (ωref) the comparator 310 generates a speed difference signal 312 (40). The reference speed signal 302 (ωref) may be associated with a reference or target speed. The current speed signal 352 (ω) may be associated with a current speed of the motor, which may be measured by a speed sensor, an encoder sensor, estimated and/or calculated by a sensorless algorithm. With an encoder, the speed feedback may be calculated or determined according to the measured position. In various embodiments utilizing sensorless algorithms, such sensorless algorithms may be a Luenberger Observer, a sliding mode observer, or the like. With a reference speed known, a speed difference may be calculated or determined.

The speed difference signal 312 (Δω) is provided to a PI regulator 320 and to a torque compensator 330. The PI regulator generates a motor torque signal 322 (Te) based on the speed difference signal 312 (Δω). The torque compensator generates a torque compensation signal 332 (Tc) based on the speed difference signal 312 (Δω). The motor torque signal 322 (Te) and the torque compensation signal 332 (Tc) are provided to a comparator 340. The comparator 340 also receives a load torque signal 304 (Tl). The comparator 340 operates by adding the motor torque signal 322 (Te) and the torque compensation signal 332 (Tc)2 and subtracting the load torque signal 304 (Tl) to generate the torque signal 342 (T).

The torque signal 342 (T) is provided to the compressor, which includes a compressor motor. The compressor 350, particularly the compressor motor, is controlled with the torque signal 342 (T) to generate the torque specified by the torque signal 342 (T). The compressor motor will be spun at a speed ω, which is measured by a speed sensor that generates a current speed signal 352 (ω). The current speed signal 352 (ω) is provided, as described, to the comparator 310. The current speed signal 352 (ω) may also be provided to an integrator 360 to generate a current angle signal 362 (θ).

In various embodiments, the PI regulator 320, which may be referred to as PI regulator circuit, may be configured to generate an output of torque compensation signal 332 (Tc) by performing a multiplication operation and an integration operation.

The PI regulator 320 is a motor controller, which may be implemented in motor control unit (MCU) or processor. The compressor compensator 330 may also be implemented in the MCU or processor. Such an MCU may calculate the torque to be provided for an application, such as to a compressor 350. In the present disclosure, this torque signal 342 (T) will include the motor torque signal 322 (Te) and torque compensation signal 332 (Tc) and, thus, the torque signal 342 (T) will include compensation for torque ripple.

In various embodiments, the PI regulator 320 may be a proportional and integral (PI) circuit that may correct for error between a setpoint and based on feedback. The PI regulator 320 may multiply the input speed difference signal 312 (Δω) it by a constant Kp and add that to an integral of total of the input speed difference signal 312 (Δω) over a period of time that is multiplied by a constant Ki. This is expressed in the formula: Te=Δω*(Kp+Ki/s).

The compressor 350 may include a speed sensor for measuring the speed (ω) and generating a speed signal 352 (ω). From the speed, an angle (θ) may be determined.

During each cycle of a compressor, a torque and/or speed of the compressor may fluctuate. Due to the torque ripple the compressor speed fluctuates with a frequency of a mechanical speed, which may be measured, such as with 3-D accelerometers. In various embodiments, such 3-D accelerometers may generate one or more acceleration signals that include an acceleration in each of the 3 dimensions.

The torque signal 342 (T) is the motor torque signal 322 (Te) plus the torque compensation signal 332 (Tc) minus the load torque signal 304 (Tl).

The motor torque signal 322 (Te) plus the torque compensation signal 332 (Tc) is related to the motor current and, with the compensation, is the new motor torque. So the output signal of the torque compensation circuit is added to the torque control signal (Te) from the PI regulator used to determine the torque signal (T) for the motor of the compressor. In various embodiments, the torque signal 342 (T) may be associated with a signal that has an amplitude associated with the torque to be provided to the compressor. Alternatively, the torque signal 342 (T) may be a value that may be provided to a compressor 350 or other process or device that will use that signal to operate a motor. In various embodiments, when a motor is in steady state with constant speed (e.g., 1000 rpm), then the motor torque signal 322 (Te) plus the torque compensation signal 332 (Tc) is equal to the load torque signal 304 (Tl) and the torque signal 342 (T) is zero. Though, as will be appreciated, the motor current is not zero.

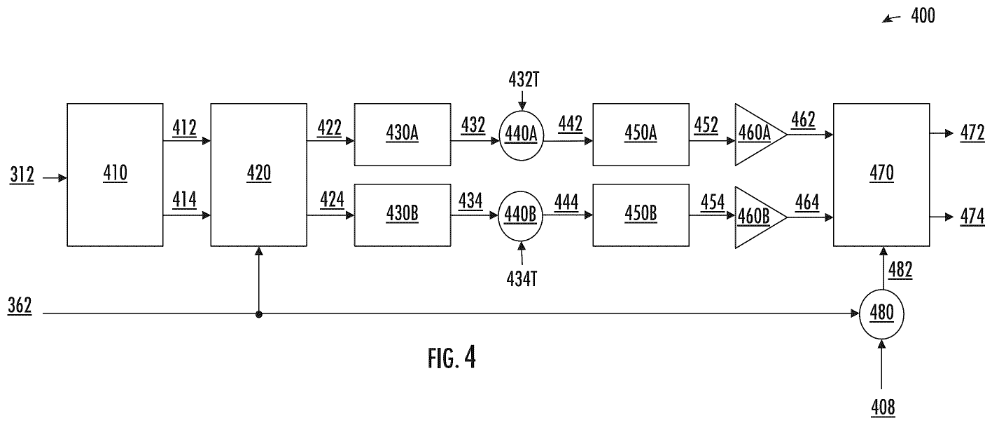

FIG. 4 illustrates a first exemplary block diagram of a flowchart of operations for generating a torque compensation signal in accordance with one or more embodiments of the present disclosure. FIG. 4 illustrates a torque compensator 330 that outputs a torque compensation signal 332 (Tc) that includes compensation for the 1st order of the frequency with a first order circuit 400.

The speed difference signal 312 (Δω) is provided to the torque compensator 330. The speed difference signal 312 (Δω) reflects the mechanical vibrations and the frequency of this signal is the same as the mechanical speed frequency. The torque compensator may include an α-β constructor 410, a Park transformer 420, a plurality of low pass filters 430 (e.g., 430A, 430B), a plurality of summers 440, 480 (e.g., 440A, 440B, 480), a plurality of PI regulators 450 (e.g., 450A, 450B), a plurality of multipliers 460 (e.g., 460A, 460B), and an inverse Park transformer 470. In various embodiments, the low pass filters 430 may be placed in another location, such as between Park transformer 420 and the plurality of summers 440. Alternatively or additionally, the low pass filters 430 may be placed anywhere between Park transformer 420 and the inverse Park transformer 470. Additionally, there may be additional low pass filters 430.

The α-β constructor 410 may be a α-β constructor circuit. The a-B constructor 410 may receive the speed difference signal 312 (Δω), construct this signal in the α-β coordinate system, and output an α speed difference signal 412 (Δω_{α}) and a β speed difference signal 414 (Δω_{β}). The α speed difference signal 412 (Δω_{α}) may be a the α component of the speed difference signal 312 (Δω) in the α-β coordinate system. The β speed difference signal 414 (Δω_{β}) may be the β component of the speed difference signal 312 (Δω) in the α-β coordinate system.

The Park transformer 420 may be a Park transform circuit. A Park transformation may convert components in a 2D coordinate system, such as the α-β coordinate system, into an orthogonal rotating reference frame—the d-q coordinate system. An alpha-beta constructor generates two signals, each in a two dimension alpha-beta coordinate system or frame. This alpha-beta coordinate system or frame, however, does not rotate with the rotor. The Park transformation is a reference frame that rotates with the axis of the rotor of a motor. The torques in both the d dimension and the q dimension of the Park transformation are associated with torque ripple. The speed difference is not exclusively on the q axis and, thus, the torque ripple has both a d component and q component. Various embodiments may use one or both of the d component and q component to reduce torque ripple.

The Park transformer 420 may extract the amplitude of the speed difference signal 312 (40) in the d-q coordinate system. The Park transformer 420 may perform a Park transformation on an input by transforming the input into an associated output in the d-q coordinate system. The α speed difference signal 412 (Δω_{α}) and the β speed difference signal 414 (Δω_{β}) may be transformed to a d speed difference signal 422 (Δω_{d}) associated with the d component of the speed difference signal 312 (Δω) and a q speed difference signal 424 (Δω₎ associated with the q component of the speed difference signal 312 (Δω) in the d-q coordinate system. The formula for these transforms may be: Δω_{d}=Δω_{α}*cos(θ)+Δω_{β}*sin(θ); and Δω_{q}=−Δω_{α}*sin(θ)+Δω_{β}*cos(θ). In these formulas, θ current angle signal 362 (θ).

Each of the plurality of low pass filters 430 (e.g., 430A, 430B) may be a low pass filter circuit. The low pass filters 430 may be, for example, tuned to pass only frequencies of the first order while blocking or attenuating higher order frequencies. This may filter out high order frequencies and leave, for the first order, only a DC component of the input signal. The d speed difference signal 422 (Δω_{d}) may be passed through a first low pass filter 430A to generate a first filtered signal 432. The q speed difference signal 424 (Δω_{q}) may be passed through a first low pass filter 430B to generate a second filtered signal 434.

Each of the plurality of summers 440, 480 (e.g., 440A, 440B, 480) may be a summation circuit. Each summer may sum one or more signals.

The summer 440A may sum a negative of the first filtered signal 432 with a first target signal 432T signal to generate an output of a target d signal 442 that is how much the first filtered signal 432 is different from the target of the first target signal 432T signal. In various embodiments, the value of the first target signal 432T is 0, which is associated with a target of an Δω of zero.

The summer 440B may sum a negative of the second filtered signal 434 with a second target signal 434T to generate an output of a target q signal 444 that is how much the second filtered signal 434 is different from the target of the second target signal 434T. In various embodiments, the value of the second target signal 434T is 0, which is associated with a target of an Δω of zero.

The summer 480 may sum a current angle signal 362 (θ) with a phase shift signal 408 signal to generate an output that is the angle of the current angle signal 362 (θ) shifted by the phase shift signal 408. In various embodiments, the value of the phase shift signal 408 is pi/2, which is associated with a 90 degree phase shift.

Each of the plurality of PI regulators 450 (e.g., 450A, 450B) may be a PI regulator circuit.

Each of the plurality of PI regulators 450 may multiply the input by a constant Kp and add that to an integral of total of the input over a period of time that is multiplied by a constant Ki to generate an output signal. This is expressed in the formula: Te=Δω*(Kp+Ki/s). A first PI regulator 450A may receive a target d signal 442 and output of a first regulated signal 452. A second PI regulator 450B may receive a target q signal 442 and output of a second regulated signal 452.

Each of the plurality of multipliers 460 (e.g., 460A, 460B) may be a multiplier circuit. In various embodiments, a multiplier circuit may multiply an input by 1 or may multiply an input by −1. A multiplier of −1 may, for example, shift the input signal by 180 degrees in the d-q coordinate system.

A first multiplier 460A may receive a first regulated signal 452, multiply it by 1, and output a torque d signal 462 (Td).

A second multiplier 460B may receive a second regulated signal 454, multiply it by −1, and output a torque q signal 464 (Tq).

The inverse Park transformer 470 may be an inverse Park transformation circuit. The inverse Park transformer 470 may transform an input signal in the d-q coordinate system to an output signal in the α-β coordinate system. The inverse Park transformer may receive a torque d signal 462 (Td), a torque q signal 464 (Tq), and phase shift signal 482 and transform them from the d-q coordinate system the α-β coordinate system and output a torque α signal 472 (Tα) and torque β signal 474 (Tβ).

The torque α signal 472 (Tα) is output as the torque compensation signal 332 (Tc). Additionally or alternatively, in various embodiments, the torque β signal 474 (Tβ) may also be used as or as a part of the torque compensation signal 332 (Tc), such as when an offset angle is changed with the phase shift signal 408. The first order circuit 400 may compensate for fluctuations and/or vibrations. As described, this is done by receiving the speed difference signal 312 (Δω) and using the α-β constructor 410 to construct the α speed difference signal 412 (Δω_{α}) and a β speed difference signal 414 (Δω_{β}). The Park transformer 420 is used to transform the α speed difference signal 412 (Δω_{α}) and the β speed difference signal 414 (Δω_{β}) into, respectively, d speed difference signal 422 (Δω_{d}) and q speed difference signal 422 (Δω_{d}) in the d-q coordinate system. Low pass filters 430 are used to filter higher order frequencies from the signals and summer circuits are used before using PI regulators 450 with multipliers 460 to generate a torque d signal 462 (Td) and a torque q signal 464 (Tq) in the d-q coordinate system. An inverse Park transform 470 is applied to generate the torque α signal 472 (Tα), which is the torque compensation signal 332 (Tc).

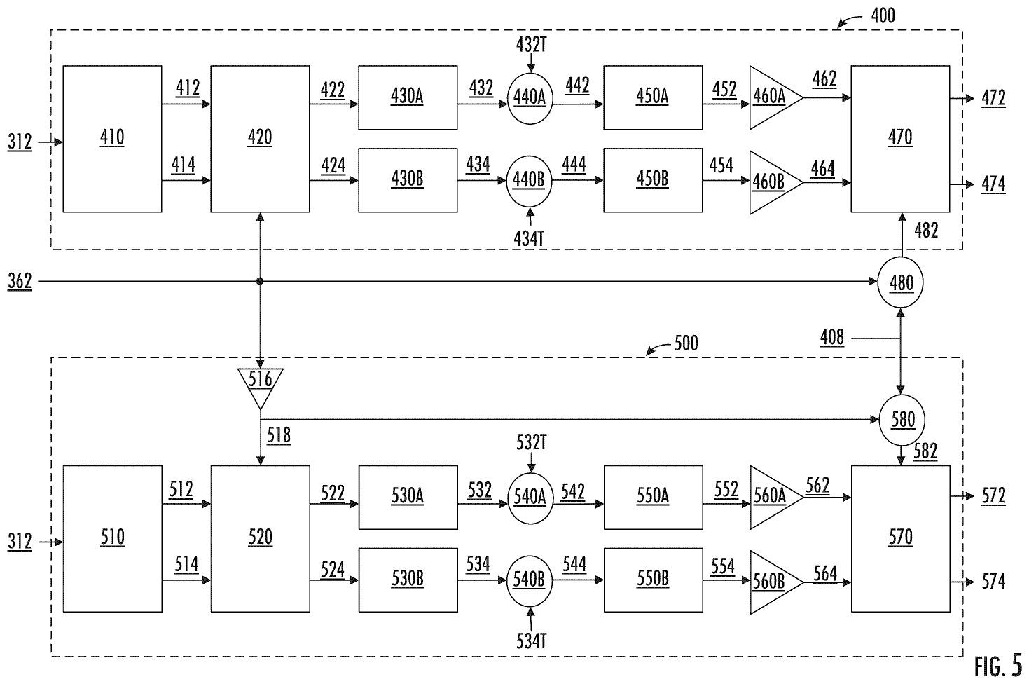

FIG. 5 illustrates a second exemplary block diagram of a flowchart of operations for generating a torque compensation signal in accordance with one or more embodiments of the present disclosure. In various embodiments, the torque compensator may also compensate for 1st order, 2nd order, and the like to an nth order harmonic of the frequency. The torque compensator 330 may be a circuit configured to perform these illustrated operations. FIG. 5 illustrates a torque compensator 330 that outputs a torque compensation signal 332 (Tc) that includes compensation for the 1st order of the frequency with a first order circuit 400 and a 2^{nd} order of the frequency with a second order circuit 500. The torque α signal 472 (Tα) may be added with the torque α_2 signal 572 (Tα_2) to be output as the torque compensation signal 332 (Tc).

The torque compensator 330 may be comprised of the first order circuit 400 and the second order circuit 500. The 1st order circuit 400 of FIG. 5 is described herein with respect to FIG. 4.

The second order circuit 500 may include an α-β constructor 510, a Park transformer 520, a plurality of low pass filters 530 (e.g., 530A, 530B), a plurality of summers 540, 580 (e.g., 540A, 540B, 580), a plurality of PI regulators 550 (e.g., 550A, 550B), a plurality of multipliers 560 (e.g., 560A, 560B), and an inverse Park transformer 570.

The α-β constructor 510 may be a α-β constructor circuit. An a-B transform performed by an α-β constructor 510 converts signals in a 3D coordinate system, such as an x-y-z coordinate system, into a 2D coordinate system, such as the α-β coordinate system. The α-β constructor 510 may receive the speed difference signal 312 (Δω), construct this signal in the α-β coordinate system, and output an α_2 speed difference signal 512 (Δω_{α_2}) and a β_2 speed difference signal 514 (Δω_{β_2}). The α_2 speed difference signal 512 (Δω_{α_2}) may be a the α component of the second order frequency of the speed difference signal 312 (Δω) in the α-β coordinate system. The β speed difference signal 514 (Δω_{β_2}) may be the β component of the second order frequency of the speed difference signal 312 (Δω) in the α-β coordinate system.

The Park transformer 520 may be a Park transform circuit. The Park transformer 520 may perform a Park transformation on an input by transforming the input into an associated output in the d-q coordinate system. The α_2 speed difference signal 512 (Δω_{α_2}) and the β_2 speed difference signal 514 (Δω_{β_2}) may be transformed to a d_2 speed difference signal 522 (Δω_{d_2}) associated with the d component of the speed difference signal 312 (Δω) and a q_2 speed difference signal 524 (Δω_{q_2}) associated with the q component of the speed difference signal 312 (Δω) in the d-q coordinate system. These transformations may be performed similarly as described for operation 420 herein.

Each of the plurality of low pass filters 530 (e.g., 530A, 530B) may be a low pass filter circuit. The low pass filters 530 may be, for example, tuned to pass only frequencies of the first order and the second order while blocking or attenuating higher order frequencies. This may filter out higher order frequencies. The d_2 speed difference signal 522 (Δω_{d_2}) may be passed through a third low pass filter 530A to generate a third filtered signal 532. The q_2 speed difference signal 524 (Δω_{q_2}) may be passed through a fourth low pass filter 530B to generate a fourth filtered signal 534.

Each of the plurality of summers 540, 580 (e.g., 540A, 540B, 580) may be a summation circuit. Each summer may sum one or more signals.

The summer 540A may sum a negative of the third filtered signal 532 with a third target signal 532T signal to generate an output of a target d_2 signal 542 that is how much the third filtered signal 532 is different from the target of the third target signal 532T signal. In various embodiments, the value of the third target signal 532T is 0, which is associated with a target of an Δω of zero.

The summer 540B may sum a negative of the fourth filtered signal 534 with a fourth target signal 534T to generate an output of a target q_2 signal 544 that is how much the fourth filtered signal 534 is different from the target of the fourth target signal 534T. In various embodiments, the value of the fourth target signal 534T is 0, which is associated with a target of an Δω of zero.

The summer 580 may sum a current angle signal 462 (θ) multiplied with a multiplier 516 and a phase shift signal 408 signal to generate an output that is a multiple of the angle of the current angle signal 362 (θ) shifted by the phase shift signal 408. In various embodiments, the multiplier 516 is multiplied by the order of the frequency of the second order circuit 500, which for multiplier 516 is 2 to correspond to the second order of the frequency, which generates an output of a double current angle signal 518 (2θ).

Each of the plurality of PI regulators 550 (e.g., 550A, 550B) may be a PI regulator circuit.

A third PI regulator 550A may receive a target d_2 signal 542 and output of a third regulated signal 552. A fourth PI regulator 450B may receive a target q_2 signal 542 and output of a fourth regulated signal 552.

Each of the plurality of multipliers 560 (e.g., 560A, 560B) may be a multiplier circuit. In various embodiments, a multiplier circuit may multiply an input by 1 or may multiply an input by −1. A multiplier of −1 may, for example, shift the input signal by 180 degrees in the d-q coordinate system.

A third multiplier 560A may receive a third regulated signal 552, multiply it by 1, and output a torque d_2 signal 562 (Td_2).

A fourth multiplier 560B may receive a fourth regulated signal 554, multiply it by −1, and output a torque q_2 signal 564 (Tq_2).

The inverse Park transformer 570 may be an inverse Park transformation circuit. The inverse Park transformer 570 may receive a torque d_2 signal 562 (Td_2), a torque q_2 signal 564 (Tq_2), and phase shift signal 582 and transform them from the d-q coordinate system the α-β coordinate system and output a torque α_2 signal 572 (Tα_2) and torque β_2 signal 474 (Tβ_2).

The torque α signal 472 (Tα) may be added with the torque α_2 signal 572 (Tα_2) to be output as the torque compensation signal 332 (Tc).

In various embodiments, higher orders of frequency may also by compensated for by adding similar higher order circuits and adjusting the associated multipliers (e.g., higher order multipliers analogous to 518) and associated low pass filters (e.g., higher order low pass filters analogous to 530) for these higher order frequencies. Thus various embodiments of the present disclosure may not only suppress the 1st order and 2^{nd} order speed frequency vibrations, but also 3rd, 4^{th}, to nth order vibrations.

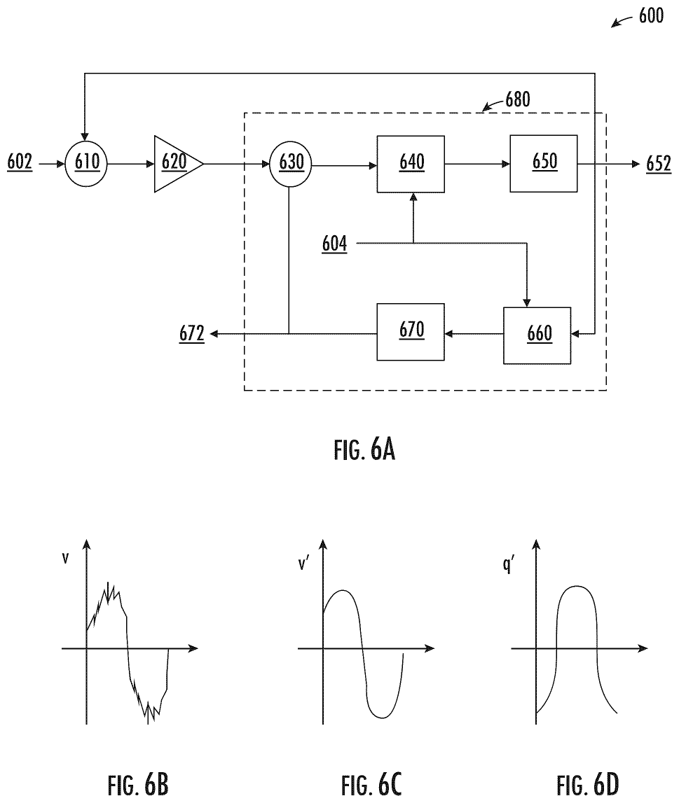

FIG. 6A-6D illustrates an exemplary block diagram of a flowchart of operations for an alpha-beta constructor and related graphs in accordance with one or more embodiments of the present disclosure. It will be appreciated that will FIGS. 6A-6D illustrate an exemplary α-β constructor, various embodiments may utilize alternative α-β constructor(s).

FIG. 6A illustrates an α-β constructor 600 may include a summer 610, a multiplier 620, and a second order generalized integrator 680. The α-β constructor 600 may receive an input 602, a ω signal 604, and output a first integral signal 604 and a second integral signal 672.

In various embodiments, the α-β constructor 600 may receive an input signal 602 that is provided to a summer 610 that sums the input signal 602 with a negative of the α signal 652. The output of the summer 610 is provided to a multiplier 620 that may apply a multiple of a constant k. The output of the multiplier 620 is provided to the second order generalized integrator 680, specifically to a summer 630 that adds this input to the negative of the β signal 672. The output of the summer 630 is provided to a multiplier 640 that multiplies this input by the @ signal 604. The output of the summer 640 is provided to an integrator 650 that integrates this input signal to generate the α signal 652. The α signal 652 is provided as an output of the α-β constructor 600 and is also feed back to the summer 610 and to a multiplier 660. The multiplier 660 multiplies the α signal 652 with the @ signal 604. The output of the multiplier 660 is provided to a second integrator 670 that generates an output of the β signal 672. The β signal is provided as an output of the α-β constructor 600 and also feedback to the summer 630.

For example, an input signal 602 may be v, which may include vibrations or fluctuations, such as illustrated in FIG. 6B. A first output of v′ may be an α signal 652 and the second output of qv′ may be the β signal 672. FIG. 6C illustrates the output of v′. FIG. 6D illustrates the output qv′. As illustrated, the α signal 652 leads the β signal 672 by 90 degrees.

Alternatively, in various embodiments the α-β constructor 600 may include or omit one or more operations. For example, various embodiments may include the α-β constructor 600 with a lower pass filter that has a 90 degree phase delay and a multiplier with a multiple of a gain to keep the amplitude the same with the input signals. The input signal may be the α signal and the may also have the β signal.

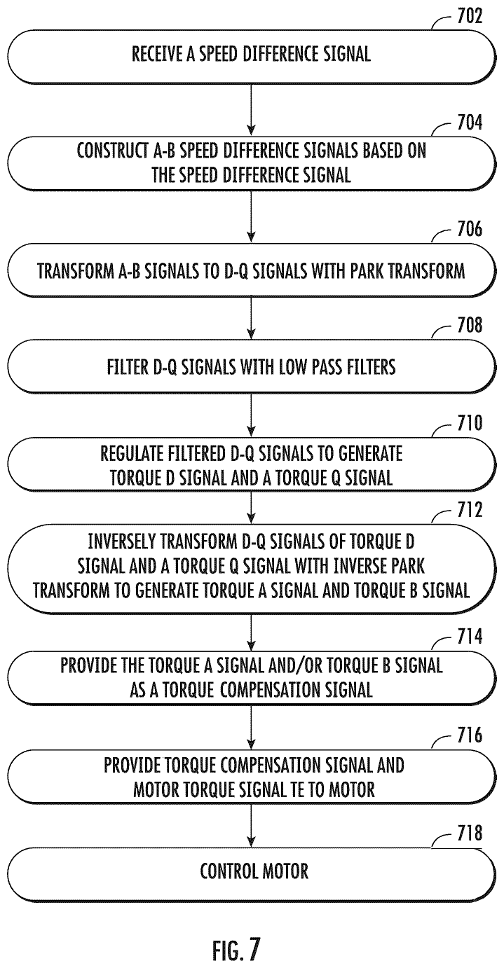

FIG. 7 illustrates exemplary operations for generating a torque compensation signal in accordance with one or more embodiments of the present disclosure.

At operation 702, receive a speed difference signal (Δω). In various embodiments, the speed difference signal (Δω) may be received from a speed sensor, which may be located in or on a motor or compressor. Alternatively, various embodiments may not include a speed sensor and the speed difference signal may be received from elsewhere, such as calculated via a sensorless algorithm, which may be calculated with a processor.

At operation 704, construct α-β speed difference signals based on the speed difference signal. The α-β speed difference signals may be, for example, the α speed difference signal (Δω_{α}) and the β speed difference signal (Δω_{β}).

At operation 706, transform α-β signals to d-q signals with Park transform. The d-q signals may be, for example, the d speed difference signal (Δω_{d}) and q speed difference signal (Δω_{d}).

At operation 708, filter d-q signals with low pass filters. The low pass filters may be, for example, configured to pass a first order frequency, which may be to pass DC currents. Filtering the d-q signals with low pass filters may result in a first filtered signal based on the d speed difference signal (Δω_{d}) and second filtered signal based on the q speed difference signal (Δω_{d})

At operation 710, regulate filtered d-q signals to generate torque d signal (Td) and a torque q signal (Tq). For example, PI regulators may be used to generate a first regulated signal based on the first filtered signal and second regulated signal based on the second filtered signal. The first regulated signal may be a torque q signal (Tq) and the second regulated signal may be a negative of a torque d signal (Td).

At operation 712, inversely transform d-q signals of torque d signal (Td) and a torque q signal (Tq) with inverse Park transform to generate torque α signal (Tα) and torque β signal (Tβ). The torque α signal (Tα) is a torque compensation signal (Tc) that may be used to compensate for torque ripple. In various embodiments, such as when there may be a change to an offset angle with the phase shift signal 408, the torque β signal (Tβ) may also be used as a torque compensation signal (Tc).

At operation 714, provide the torque α signal (Tα) and/or torque β signal (Tβ) as a torque compensation signal (Tc).

At operation 716, provide torque compensation signal (Tc) and motor torque signal (Te) to the motor. The torque compensation signal (Tc) plus the motor torque signal (Te) are the real motor torque.

At operation 718, control motor with the torque compensation signal (Tc) and motor torque signal (Te). The motor may operate based on these signals to eliminate or reduce the torque ripple. In various embodiments, these signals may be used to generate pulse width modulation (PWM) signals that may be used to drive an inverter and generate torque for controlling a motor.

In various embodiments, one or more additional operations may be included. For example, in various embodiments, a torque ripple compensation mode may be enabled (or disabled) when a motor controller may, for example, determine when frequencies are identified that may be above a certain threshold, below a certain threshold, or in a range. For example, various embodiments may enable torque ripple compensation described herein when frequencies in a range of 20 Hz to 40 Hz. As a further example, various embodiments may enable torque ripple compensation described herein for frequencies over a full speed range of a motor. In various embodiments, torque ripple compensation may be enabled (or disabled) when a motor speed is above a certain threshold, below a certain threshold, or within a range.

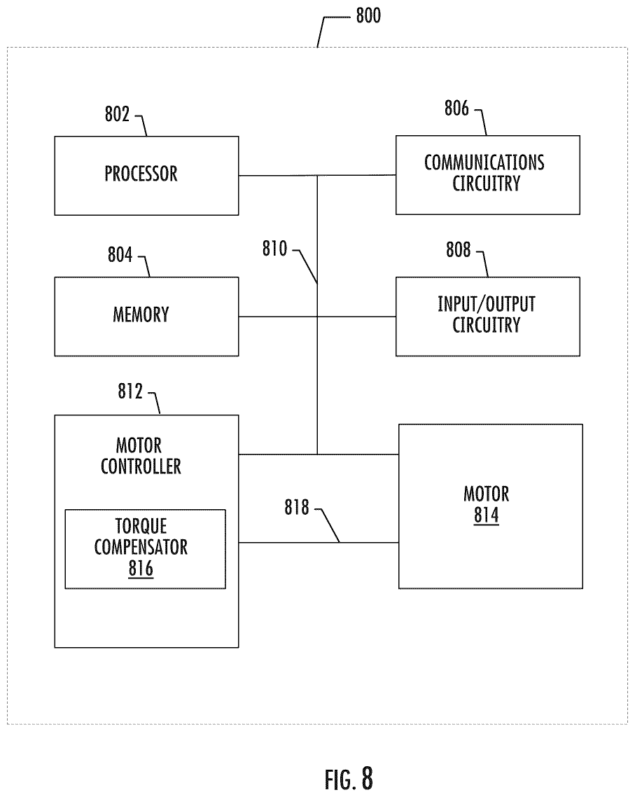

FIG. 8 illustrates an exemplary device in accordance with one or more embodiments of the present disclosure. The device 800 may be a device for an application and/or a system. For example, the device 800 may be a motor, compressor, air conditioner, refrigerator, etc. The device 800 illustrated may be a system and/or apparatus that includes a processor 802, memory 804, communications circuitry 806, input/output circuitry 808, motor controller 812, motor 814 and all of which may be connected by a bus or buses 810. Additionally, the motor controller may be connected by a bus 818 to the motor 814. While such connections are illustrated as bus 810 and 818, it will be readily appreciated that there may be multiple other connections.

The processor 802, although illustrated as a single block, may be comprised of a plurality of components and/or processor circuitry. The processor 802 may be implemented as, for example, various components comprising one or a plurality of microprocessors with accompanying digital signal processors; one or a plurality of processors without accompanying digital signal processors; one or a plurality of coprocessors; one or a plurality of multi-core processors; processing circuits; and various other processing elements. The processor may include integrated circuits. In various embodiments, the processor 802 may be configured to execute applications, instructions, and/or programs stored in the processor 802, memory 804, or otherwise accessible to the processor 802. When executed by the processor 802, these applications, instructions, and/or programs may enable the execution of one or a plurality of the operations and/or functions described herein. Regardless of whether it is configured by hardware, firmware/software methods, or a combination thereof, the processor 802 may comprise entities capable of executing operations and/or functions according to the embodiments of the present disclosure when correspondingly configured.

The memory 804 may comprise, for example, a volatile memory, a non-volatile memory, or a certain combination thereof. Although illustrated as a single block, the memory 804 may comprise a plurality of memory components. In various embodiments, the memory 804 may comprise, for example, a random access memory, a cache memory, a flash memory, a hard disk, a circuit configured to store information, or a combination thereof. The memory 804 may be configured to write or store data, information, application programs, instructions, etc. so that the processor 804 may execute various operations and/or functions according to the embodiments of the present disclosure. For example, in at least some embodiments, a memory 804 may be configured to buffer or cache data for processing by the processor 802. Additionally or alternatively, in at least some embodiments, the memory 804 may be configured to store program instructions for execution by the processor 802. The memory 804 may store information in the form of static and/or dynamic information. When the operations and/or functions are executed, the stored information may be stored and/or used by the processor 802.

The communication circuitry 806 may be implemented as a circuit, hardware, computer program product, or a combination thereof, which is configured to receive and/or transmit data from/to another component or apparatus. The computer program product may comprise computer-readable program instructions stored on a computer-readable medium (e.g., memory 804) and executed by a processor 802. In various embodiments, the communication circuitry 806 (as with other components discussed herein) may be at least partially implemented as part of the processor 802 or otherwise controlled by the processor 802. The communication circuitry 806 may communicate with the processor 802, for example, through a bus 810. Such a bus 810 may connect to the processor 802, and it may also connect to one or more other components of the processor 802. The communication circuitry 806 may be comprised of, for example, transmitters, receivers, transceivers, network interface cards and/or supporting hardware and/or firmware/software, and may be used for establishing communication with another component(s), apparatus(es), and/or system(s). The communication circuitry 806 may be configured to receive and/or transmit data that may be stored by, for example, the memory 804 by using one or more protocols that can be used for communication between components, apparatuses, and/or systems.

The input/output circuitry 808 may communicate with the processor 802 to receive instructions input by an operator and/or to provide audible, visual, mechanical, or other outputs to an operator. The input/output circuitry 808 may comprise supporting devices, such as a keyboard, a mouse, a user interface, a display, a touch screen display, lights (e.g., warning lights), indicators, speakers, and/or other input/output mechanisms. The input/output circuitry 808 may comprise one or more interfaces to which supporting devices may be connected. In various embodiments, aspects of the input/output circuitry 808 may be implemented on a device used by the operator to communicate with the processor 802. The input/output circuitry 808 may communicate with the memory 804, the communication circuitry 806, and/or any other component, for example, through a bus 810.

The motor controller 812 may communicate with the processor 802 to perform one or more operations described herein. The motor controller 812 may include, among other things, a torque compensator 816. The torque compensator 816 may be configured as described herein, including to compensate for one or more orders of frequencies experienced by a motor 814. In various embodiments, the motor controller 812 may receive one or more signals from the processor 802, communications circuitry 806, and/or input/output circuitry 808, such as to start or stop operations. In various embodiments, the motor controller 812 may in integrated into the motor 814.

The motor 814 may provide a torque to a load via a motor shaft. The motor 814 may be controlled by the motor controller 812. In various embodiments, the motor 814 may receive one or more signals from the processor 802, communications circuitry 806, and/or input/output circuitry 808, such as to start or stop operations. Additionally or alternatively, the motor 814 may also receive one or more signals, such as power, from input/output circuitry 808.

It should be readily appreciated that the embodiments of the systems and apparatuses, described herein may be configured in various additional and alternative manners in addition to those expressly described herein.

### CONCLUSION

Operations and/or functions of the present disclosure have been described herein, such as in flowcharts. As will be appreciated, computer program instructions may be loaded onto a computer or other programmable apparatus (e.g., hardware) to produce a machine, such that the resulting computer or other programmable apparatus implements the operations and/or functions described in the flowchart blocks herein. These computer program instructions may also be stored in a computer-readable memory that may direct a computer, processor, or other programmable apparatus to operate and/or function in a particular manner, such that the instructions stored in the computer-readable memory produce an article of manufacture, the execution of which implements the operations and/or functions described in the flowchart blocks. The computer program instructions may also be loaded onto a computer, processor, or other programmable apparatus to cause a series of operations to be performed on the computer, processor, or other programmable apparatus to produce a computer-implemented process such that the instructions executed on the computer, processor, or other programmable apparatus provide operations for implementing the functions and/or operations specified in the flowchart blocks. The flowchart blocks support combinations of means for performing the specified operations and/or functions and combinations of operations and/or functions for performing the specified operations and/or functions. It will be understood that one or more blocks of the flowcharts, and combinations of blocks in the flowcharts, can be implemented by special purpose hardware-based computer systems which perform the specified operations and/or functions, or combinations of special purpose hardware with computer instructions.

While this specification contains many specific embodiments and implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

While operations and/or functions are illustrated in the drawings in a particular order, this should not be understood as requiring that such operations and/or functions be performed in the particular order shown or in sequential order, or that all illustrated operations be performed, to achieve desirable results. In certain circumstances, operations and/or functions in alternative ordering may be advantageous. In some cases, the actions recited in the claims may be performed in a different order and still achieve desirable results. Thus, while particular embodiments of the subject matter have been described, other embodiments are within the scope of the following claims.

While this detailed description has set forth some embodiments of the present invention, the appended claims cover other embodiments of the present invention which differ from the described embodiments according to various modifications and improvements.

Within the appended claims, unless the specific term “means for” or “step for” is used within a given claim, it is not intended that the claim be interpreted under 35 U.S.C. § 112, paragraph 6.

1. A method of torque ripple compensation comprising:
receiving a speed difference signal, wherein the speed difference signal is associated with a difference between a motor speed and a reference speed;
generating a torque compensation signal by:
generating, via an α-β construct, one or more α-β signals based speed difference signal;
converting, via a Park transform, the one or more α-β signals to one or more transformed signals;
filtering the one or more transformed signals with one or more low pass filters to provide one or more filtered signals;
regulating, via one or more PI regulators, the one or more filtered signals to provide one or more regulated signals;
converting, with an inverse Park transform, the one or more regulated signals to a torque compensation signal; and
controlling a motor based at least on the torque compensation signal.

2. The method of claim 1, wherein generating the torque compensation compensates for the first order frequencies and the second order frequencies.

3. The method of claim 1, wherein the speed difference signal is received based on a speed signal determined by one or more 3D accelerometers, an encoder, or a sensorless algorithm.

4. The method of claim 1, wherein generating the torque compensation signal occurs when the motor speed is above a first threshold.

5. The method of claim 1, wherein generating the torque compensation signal occurs when a speed signal is in a range above a first threshold and below a second threshold.

6. The method of claim 1, wherein the method is performed by a motor controller.

7. The method of claim 1, wherein the motor is a compressor motor for an air conditioner or a refrigerator.

8. An apparatus for torque ripple compensation comprising:
a memory;
a processor;
a motor controller configured to control a motor and communicable with the processor and the memory, wherein the motor controller is further configured to:
receive a speed difference signal, wherein the speed difference signal is associated with a difference between a motor speed and a reference speed;
generate a torque compensation signal by:
generate, via an α-β construct, one or more α-β signals based speed difference signal;
convert, via a Park transform, the one or more α-β signals to one or more transformed signals;
filter the one or more transformed signals with one or more low pass filters to provide one or more filtered signals;
regulate, via one or more PI regulators, the one or more filtered signals to provide one or more regulated signals;
convert, with an inverse Park transform, the one or more regulated signals to a torque compensation signal; and
control a motor based at least on the torque compensation signal.

9. The apparatus of claim 8, wherein to generate the torque compensation compensates for the first order frequencies and the second order frequencies.

10. The apparatus of claim 8, wherein the speed difference signal is to be received based on a speed signal determined by one or more 3D accelerometers, an encoder, or a sensorless algorithm.

11. The apparatus of claim 8, wherein to generate the torque compensation signal occurs when the motor speed is above a first threshold.

12. The apparatus of claim 8, wherein to generate the torque compensation signal occurs when a speed signal is in a range above a first threshold and below a second threshold.

13. The apparatus of claim 12, wherein the first threshold is 20 Hz and the second threshold is 40 Hz.

14. The apparatus of claim 8, wherein the motor is a compressor motor for an air conditioner or a refrigerator.

15. A system for torque ripple compensation comprising:
a motor;
a memory;
a processor;
a motor controller configured to control the motor and communicable with the processor and the memory, wherein the motor controller is further configured to:
receive a speed difference signal, wherein the speed difference signal is associated with a difference between a motor speed and a reference speed;
generate a torque compensation signal by:
generate, via an α-β construct, one or more α-β signals based speed difference signal;
convert, via a Park transform, the one or more α-β signals to one or more transformed signals;
filter the one or more transformed signals with one or more low pass filters to provide one or more filtered signals;
regulate, via one or more PI regulators, the one or more filtered signals to provide one or more regulated signals;
convert, with an inverse Park transform, the one or more regulated signals to a torque compensation signal; and
control a motor based at least on the torque compensation signal.

16. The system of claim 15, wherein to generate the torque compensation compensates for the first order frequencies and the second order frequencies.

17. The system of claim 15, wherein the speed difference signal is to be received based on a speed signal determined by one or more 3D accelerometers, an encoder, or a sensorless algorithm.

18. The system of claim 15, wherein to generate the torque compensation signal occurs when the motor speed is above a first threshold.

19. The system of claim 15, wherein to generate the torque compensation signal occurs when a speed signal is in a range above a first threshold and below a second threshold.

20. The system of claim 15, wherein the motor is a compressor motor for an air conditioner or a refrigerator.
